(19) United States
(12) Patent Application Publication
(10) Pub. No.: US 2023/0316961 A1
(43) Pub. Date: Oct. 5, 2023

(54) SYSTEM AND METHOD FOR IMAGE DISPLAYING

(71) Applicant: ViewSonic International Corporation, New Taipei City (TW)

(72) Inventors: Jia-Shin Tsai, New Taipei City (TW); Kun-Tsang Yang, New Taipei City (TW); Shun-Chang Chen, New Taipei City (TW)

(73) Assignee: ViewSonic International Corporation, New Taipei City (TW)

(21) Appl. No.: 18/192,680

(22) Filed: Mar. 30, 2023

(30) Foreign Application Priority Data
Apr. 1, 2022 (TW) 111112799

(51) Int. Cl. G09G 3/00

(52) U.S. Cl. CPC G09G 3/001; G09G 2370/20; G09G 2354/00; G09G 2340/0435

(57) ABSTRACT

A system and a method for image displaying are disclosed. The system for image displaying includes a first source device, a second source device, a display, and multiple image filtering devices. The first source device is configured to transmit a first image stream. The second source device is configured to transmit a second image stream. The display receives the first image stream and the second image stream, uses a predetermined frame rate to accordingly play a reconstructed image content, and provides a synchronization signal corresponding to the predetermined frame rate. The reconstructed image content is interleaved with a first image content corresponding to the first image stream and a second image content corresponding to the second image stream. Each of the image filtering devices includes an image display shutter. The image display shutter is switched between opening and closing according to the synchronization signal.

### CROSS-REFERENCE TO RELATED APPLICATION

This application claims the priority benefit of Taiwan application serial no. 111112799, filed on Apr. 1, 2022. The entirety of the above-mentioned patent application is hereby incorporated by reference herein and made a part of this specification.

### BACKGROUND

### Technical Field

The invention relates to a system and a method for image displaying, and more particularly, to a system and a method for image displaying that users may view different contents on one display at the same time.

### Description of Related Art

Due to rapid development of science and technology, applications and functions of displays are continuously diversified. In addition to the function of watching wireless and cable TV, the display may also be used in collaboration with a video game console or used as a display device of a personal computer.

If multiple viewers want to watch different contents on one display at the same time, most displays currently use a picture-in-picture (PiP) or picture-by-picture (PBP) technique to display the different contents. However, disadvantages of the above method are that an image size is small, and for the viewers, more than two types of different images are displayed on one display at the same time, which may cause mutual interference and inability of concentration, thereby affecting a viewing experience.

### SUMMARY

The invention relates to a system and a method for image displaying, which are adapted to be used in collaboration with image filtering devices to enable viewers to view desired image contents on one display at the same time.

The invention provides a system for image displaying including a first source device, a second source device, a display, and multiple image filtering devices. The first source device is configured to transmit a first image stream. The second source device is configured to transmit a second image stream. The display is coupled to the first source device and the second source device, receives the first image stream and the second image stream, uses a predetermined frame rate to accordingly play a reconstructed image content, and provides a synchronization signal corresponding to the predetermined frame rate. The reconstructed image content is interleaved with a first image content corresponding to the first image stream and a second image content corresponding to the second image stream. Each of the image filtering devices includes an image display shutter. The image display shutter is switched between opening and closing according to the synchronization signal.

The invention provides a method for image displaying suitable for viewing an image content through an image filtering device including an image display shutter, which includes the following steps. A first image stream and a second image stream are transmitted. The first image stream and the second image stream are received, a predetermined frame rate is used to accordingly play a reconstructed image content, and a synchronization signal corresponding to the predetermined frame rate is provided. The reconstructed image content is interleaved with a first image content corresponding to the first image stream and a second image content corresponding to the second image stream. The image display shutter is switched between opening and closing according to the synchronization signal.

Based on the above, the system and the method for image displaying in the invention allow multiple viewers to watch different image contents on one display at the same time through the assistance of the image filtering devices, which not only improves the convenience of use, but also does not cause mutual interference.

In order for the aforementioned features and advantages of the invention to be more comprehensible, several embodiments accompanied with drawings are described in detail as follows.

### BRIEF DESCRIPTION OF THE DRAWINGS

FIG. 1 is a schematic block diagram of a system for image displaying according to an embodiment of the invention.

FIG. 2 is a flowchart of a method for image displaying according to an embodiment of the invention.

FIG. 3 is an example of a method for image displaying according to an embodiment of the invention.

FIG. 4A to FIG. 4C are examples of a method for image displaying according to an embodiment of the invention.

### DESCRIPTION OF THE EMBODIMENTS

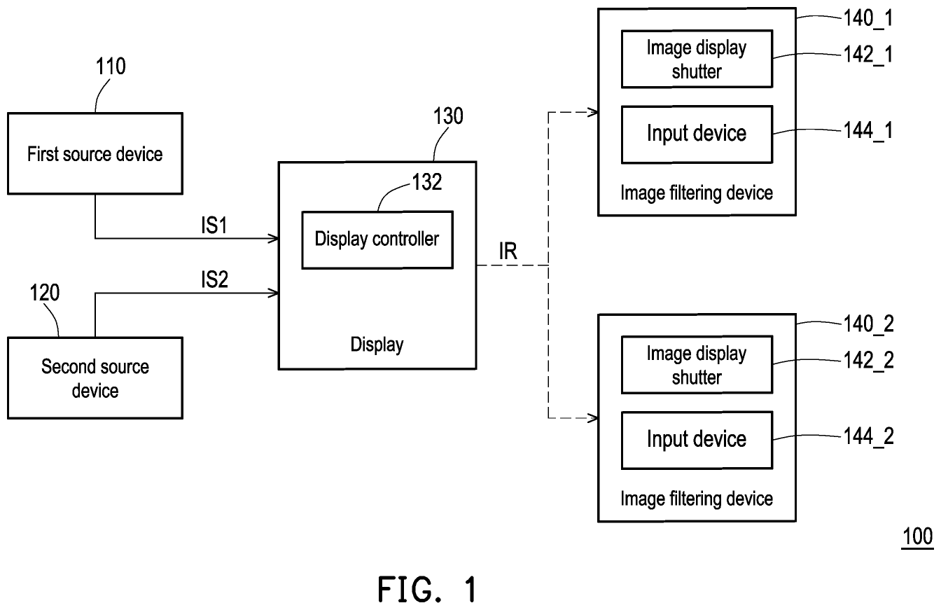

FIG. 1 is a schematic block diagram of a system for image displaying according to an embodiment of the invention. Referring to FIG. 1, a system 100 for image displaying of the embodiment includes a first source device 110, a second source device 120, a display 130, an image filtering device 140_1, and an image filtering device 140_2, and functions of these devices are described below.

The first source device 110 and the second source device 120 are, for example, electronic devices such as digital media players, video game consoles (for example, PlayStations, XBOXs or Switches, etc.) or personal computers, etc., that may support various specifications of display port streaming technology to provide image streams. As shown in FIG. 1, the first source device 110 and the second source device 120 are coupled to the display 130. The first source device 110 may transmit a first image stream IS1 to the display 130 through, for example, a transmission line, and the second source device 120 may, for example, transmit a second image stream IS2 to the display 130 through a transmission line.

The display 130 is, for example, a display using a liquid crystal display (LCD) panel, a light-emitting diode (LED) panel, a field emission display (FED) panel or other types of panels. As shown in FIG. 1, the display 130 includes a display controller 132 having an image stream processing function.

The image filtering device 140_1 includes an image display shutter 142_1 and an input device 144_1. The image filtering device 140_2 includes an image display shutter 142_2 and an input device 144_2. The image filtering devices 140_1 and 140_2 are, for example, smart glasses wearable on the viewers or glass screens installed between the viewers and the display 130, but the invention is not limited thereto.

The image display shutters 142_1 and 142_2 are, for example, optical shutters made of materials such as electrochromic compounds or liquid crystal compounds, etc., and may be opened or closed under control of a synchronization signal IR. It should be noted that in the embodiment, “open” means that the image filtering device presents a transparent state and does not affect a viewer's sight, and in the embodiment, “close” means that the image filtering device presents a completely black state and blocks the viewer's sight.

The input devices 144_1 and 144_2 are, for example, input buttons, remote controllers, touchpads or touch panels with resistive, capacitive or other types of touch sensing elements, which may receive a selection operation from the viewer to select the image contents to be watched through the image filtering devices 140_1 and 140_2.

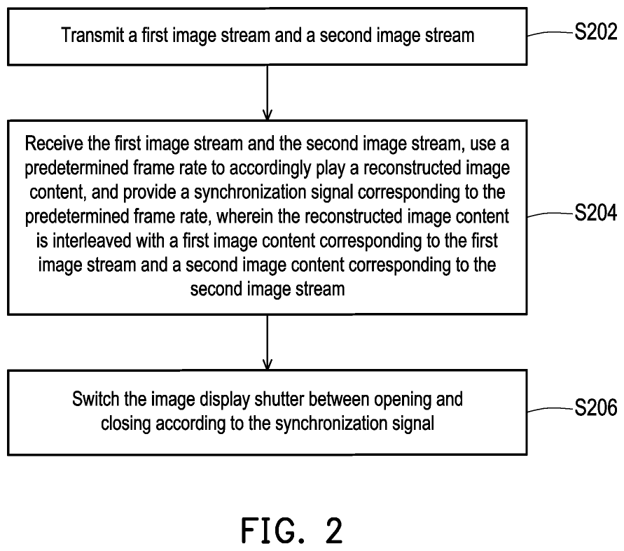

FIG. 2 is a flowchart of a method for image displaying according to an embodiment of the invention. Referring to FIG. 1 and FIG. 2 at the same time, the method for image displaying in the embodiment is applicable to the system 100 for image displaying in FIG. 1, and various steps of the method for image displaying in the embodiment of the invention are described below with reference of various components in the system 100 for image displaying.

In step S202, the first source device 110 transmits the first image stream IS1 to the display 130, and the second source device 120 transmits the second image stream IS2 to the display 130. The first image stream IS1 and the second image stream IS2 are, for example, image streams with different contents.

Then, in step S204, the display 130 receives the first image stream IS1 and the second image stream IS2, and uses a predetermined frame rate to accordingly play a reconstructed image content, and provide the synchronization signal IR corresponding to the predetermined frame rate. The reconstructed image content is interleaved with a first image content corresponding to the first image stream IS1 and a second image content corresponding to the second image stream IS2. To be specific, the display controller 132 in the display 130 may sequentially interleave the first image stream IS1 and the second image stream IS2 according to the predetermined frame rate for reconstruction, so as to generate a reconstructed image stream. In the embodiment, the predetermined frame rate is one of the frame rates supported by the display 130, which is, for example, 60 Hz. In the reconstructed image stream of the embodiment, an interleaving frequency of the first image stream IS1 and the second image stream IS2 is equal to the predetermined frame rate. Accordingly, the display 130 may play a reconstructed image content interleaved with the first image content and the second image content according to the reconstructed image stream.

In addition, the display controller 132 may also provide the synchronization signal IR according to the interleaving frequency (equal to the predetermined frame rate) of the first image stream IS1 and the second image stream IS2. In the embodiment, the dotted line indicates that the synchronization signal IR is, for example, an infrared signal that may be transmitted wirelessly, but the invention is not limited thereto.

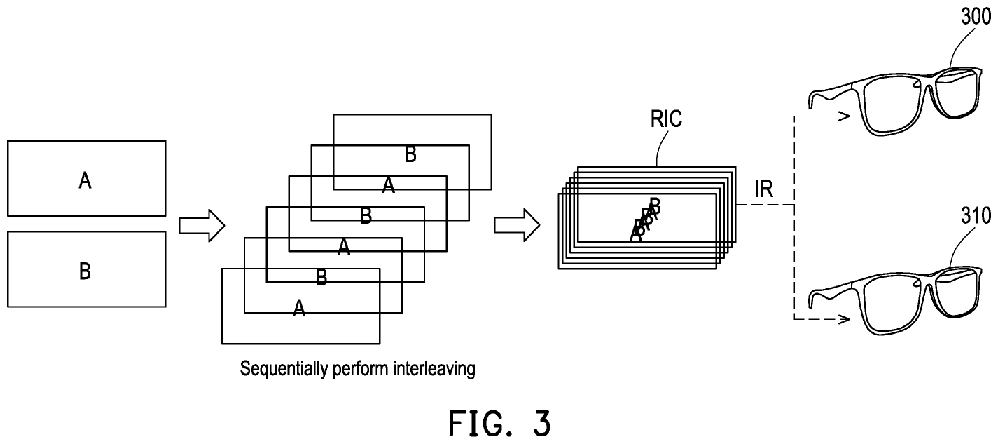

FIG. 3 is an example of a method for image displaying according to an embodiment of the invention. Referring to FIG. 3, the first image content A and the second image content B are shown on the far left. Following the arrow to the right, the first image content A and the second image content B are sequentially interleaved to form a reconstructed image content RIC, and the synchronization signal IR is provided to the smart glasses 300 and 310 (corresponding to the image filtering devices 140_1 and 140_2) worn by the viewers.

Referring back to FIG. 2, finally, in step 206, the image display shutter 142_1 in the image filtering device 140_1 and the image display shutter 142_2 in the image filtering device 140_2 may be switched between opening and closing according to the synchronization signal IR. The synchronization signal IR is, for example, a pulse wave signal with a same frequency as the predetermined frame rate. Therefore, a rising edge of the synchronization signal IR may be synchronized with a timing of interleaving the first image content and the second image content in the reconstructed image content. For example, the image display shutters 142_1 and 142_2 may count the rising edges of the synchronization signal IR, so as to open or close when a counting value is odd or even according to the selected image content.

Moreover, in the embodiment, during playing of the reconstructed image content, the display 130 displays a first frame rate of the first image content and a second frame rate of the second image content, both of which are a half of the predetermined frame rate, such as 30 Hz.

Taking the image filtering device 140_1 as an example, when the viewer inputs a selection operation to the input device 144_1 of the image filtering device 140_1 to select and display the first image content, the image display shutter 142_1 in the image filtering device 140_1 may be opened when the counting value of the synchronization signal IR is an odd number, and closed when the counting value is an even number, thereby synchronizing a shutter opening timing with a timing of the display 130 playing the first image content, and synchronizing a shutter closing timing with a timing of the display 130 playing the second image content. In other words, the image display shutter 142_1 is opened when the reconstructed image content is the first image content, and the image display shutter 142_1 is closed when the reconstructed image content is the second image content, and is constantly switched between opening and closing. In this way, the viewer only views the first image content on the display 130 and does not experience interruption due to the persistence of vision.

On the other hand, when the viewer inputs a selection operation to the input device 144_1 of the image filtering device 140_1 to select and display the second image content, the image display shutter 142_1 in the image filtering device 140_1 may be opened when the counting value of the synchronization signal IR is an even number, and closed when the counting value is an odd number, thereby synchronizing a shutter opening timing with a timing of the display 130 playing the second image content, and synchronizing a shutter closing timing with a timing of the display 130 playing the first image content. In other words, the image display shutter 142_1 is opened when the reconstructed image content is the second image content, and the image display shutter 142_1 is closed when the reconstructed image content is the first image content, and is constantly switched between opening and closing. In this way, the viewer only views the second image content on the display 130 and does not experience interruption due to the persistence of vision.

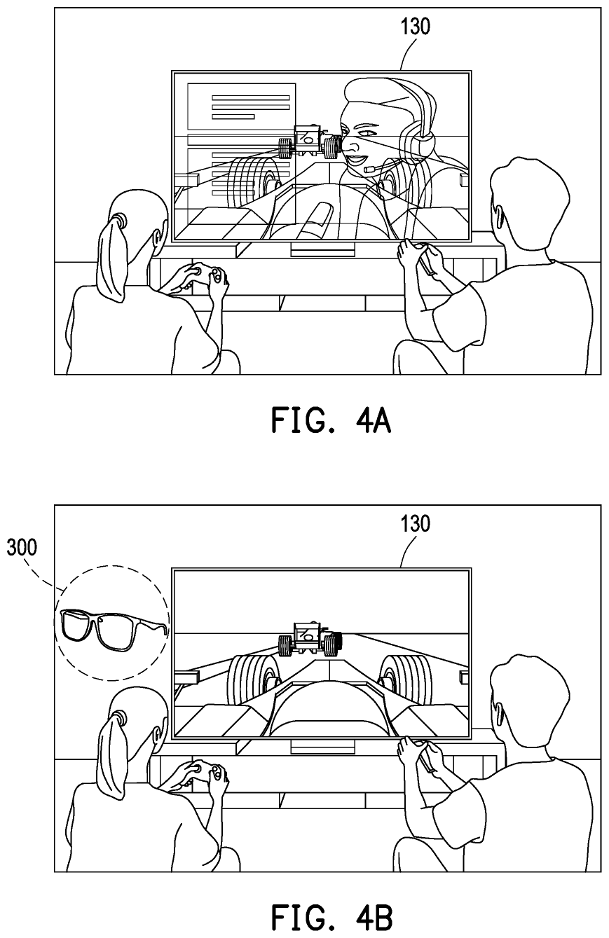

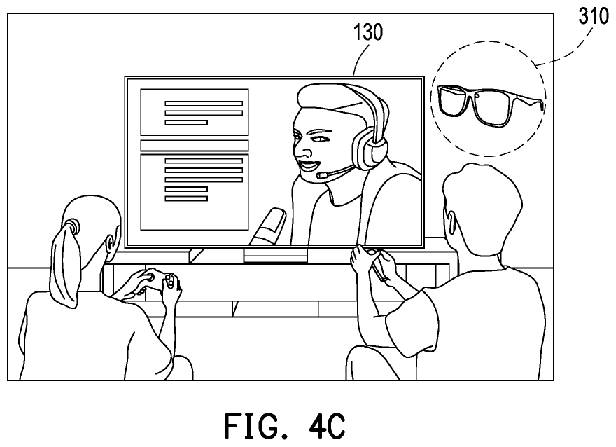

FIG. 4A to FIG. 4C are examples of a method for image displaying according to an embodiment of the invention. In FIG. 4A, the display 130 plays the reconstructed image content interleaved with the first image content and the second image content. As shown in FIG. 4A, from a naked eye perspective, due to the persistence of vision, the first image content and the second image content played on the display 130 appear to be mixed together and displayed at the same time, and the image content is not clear.

In FIG. 4B, the display 130 displays the image content viewed through the smart glasses 300 when one of the viewers wearing the smart glasses 300 selects the first image content. As shown in FIG. 4B, the viewer may only view the clear first image content (images of a racing game), and will not experience interruption due to the persistence of vision.

In FIG. 4C, the display 130 displays the image content viewed through the smart glasses 310 when another viewer wearing the smart glasses 310 selects the second image content. As shown in FIG. 4C, the viewer may only view the clear second image content (images of anchor's live broadcast), and will not experience interruption due to the persistence of vision.

Through the above method, multiple viewers may view different image contents on one display in full screen at the same time, which improves the convenience of use. In addition, if one of the image contents is set as a confidential content, it may also be designed to be viewed only by an authenticated viewer, so as to achieve an effect of confidentiality.

It should be noted that although the embodiment is described with reference of the system 100 for image displaying including two source devices (the first source device 110 and the second source device 120), the number of the source devices mentioned above is not limited by the invention. As long as it complies with the teaching of the invention to transmit images streams by using the same frame rate that conforms to specifications of the display, those skilled in the art may use more number of the source devices according to the teachings of the invention based on their actual needs, so as to provide more image contents for each viewer to choose.

Similarly, although the embodiment is described with reference of the system 100 for image displaying including two image filtering devices 140_1 and 140_2, the number of the above image filtering devices is not limited in the invention. Those skilled in the art may use a greater number of the image filtering devices according to the teaching of the embodiment based on their actual needs.

In addition, it should be noted that in the aforementioned embodiments, the image filtering devices are described as being worn on the viewers as smart glasses, but the invention is not limited thereto. In another embodiment of the invention, the method for image displaying in the invention may also be applied, for example, to an electronic flight timetable of an airport. A glass screen may be installed as an image filtering device between the viewers and the electronic flight timetable. The viewers may perform selection operations on the glass screen to quickly inquire about the flight they want to take through the glass screen. The flight timetable may also be played in a non-conventional carousel mode, and passengers do not need to wait until the desired flight information is played, according to the method of the invention, all information will be displayed on the image at one time, and the flight information of different pages may be displayed simultaneously through different glass screens, which saves a waiting time of the passenger for the carousel, the display pages may be switched on the respective glass screens at any time.

In summary, the system and the method for image displaying in the invention allow multiple viewers to watch different image contents on one display in full screen at the same time through the assistance of the image filtering devices, which not only improves the convenience of use, but also does not cause mutual interference. Moreover, if one of the image contents is set as a confidential content, it may also be designed to be viewed only by an authenticated viewer, thereby achieving the effect of confidentiality.

What is claimed is:

1. A system for image displaying, comprising:
a first source device configured to transmit a first image stream;
a second source device configured to transmit a second image stream;
a display coupled to the first source device and the second source device, receiving the first image stream and the second image stream, using a predetermined frame rate to accordingly play a reconstructed image content, and providing a synchronization signal corresponding to the predetermined frame rate, wherein the reconstructed image content is interleaved with a first image content corresponding to the first image stream and a second image content corresponding to the second image stream; and
a plurality of image filtering devices, wherein each of the image filtering devices comprises an image display shutter, and the image display shutter is switched between opening and closing according to the synchronization signal.

2. The system for image displaying according to claim 1, wherein the display comprises:
a display controller sequentially interleaving the first image stream and the second image stream according to the predetermined frame rate for reconstruction to generate a reconstructed image stream,
the display plays the reconstructed image content according to the reconstructed image stream.

3. The system for image displaying according to claim 2, wherein the display controller provides the synchronization signal according to an interleaving frequency of the first image stream and the second image stream.

4. The system for image displaying according to claim 1, wherein each of the image filtering devices comprises an input device, the input device is configured to receive a selection operation to select an image content to be displayed by each of the image filtering devices.

5. The system for image displaying according to claim 4, wherein when the selection operation selects to display the first image content, the image display shutter in the corresponding image filtering devices synchronizes a shutter opening timing with a timing of the display playing the first image content, and synchronizes a shutter closing timing with a timing of the display playing the second image content according to the synchronization signal,
when the selection operation selects to display the second image content, the image display shutter in the corresponding image filtering devices synchronizes the shutter opening timing with the timing of the display playing the second image content, and synchronizes the shutter closing timing with the timing of the display playing the first image content according to the synchronization signal.

6. The system for image displaying according to claim 1, wherein during a period when the display plays the reconstructed image content, a first frame rate for displaying the first image content on the display is the same as a second frame rate for displaying the second image content.

7. The system for image displaying according to claim 1, wherein the synchronization signal is an infrared signal.

8. A method for image displaying, suitable for viewing an image content through an image filtering device comprising an image display shutter, wherein the method for image displaying comprises:
transmitting a first image stream and a second image stream;
receiving the first image stream and the second image stream, using a predetermined frame rate to accordingly play a reconstructed image content, and providing a synchronization signal corresponding to the predetermined frame rate, wherein the reconstructed image content is interleaved with a first image content corresponding to the first image stream and a second image content corresponding to the second image stream; and
switching the image display shutter between opening and closing according to the synchronization signal.

9. The method for image displaying according to claim 8, wherein using the predetermined frame rate to accordingly play the reconstructed image content comprises:
sequentially interleaving the first image stream and the second image stream according to the predetermined frame rate for reconstruction, so as to generate a reconstructed image stream,
playing the reconstructed image content according to the reconstructed image stream.

10. The method for image displaying according to claim 9, wherein providing the synchronization signal corresponding to the predetermined frame rate comprises:
providing the synchronization signal according to an interleaving frequency of the first image stream and the second image stream.

11. The method for image displaying according to claim 8, further comprising:
receiving a selection operation to select an image content to be displayed by each of the image filtering devices.

12. The method for image displaying according to claim 11, wherein after receiving the selection operation, the method further comprises:
when the selection operation selects to display the first image content, synchronizing a shutter opening timing of the image display shutter with a timing of playing the first image content, and synchronizing a shutter closing timing of the image display shutter with a timing of playing the second image content according to the synchronization signal; and
when the selection operation selects to display the second image content, synchronizing the shutter opening timing of the image display shutter with the timing of playing the second image content, and synchronizing the shutter closing timing of the image display shutter with the timing of playing the first image content according to the synchronization signal.

13. The method for image displaying according to claim 8, wherein during a period of playing the reconstructed image content, a first frame rate for displaying the first image content is the same as a second frame rate for displaying the second image content.

14. The method for image displaying according to claim 8, wherein the synchronization signal is an infrared signal.
